(19) United States
(12) Patent Application Publication
(10) Pub. No.: US 2026/0247097 A1
(43) Pub. Date: Aug. 20, 2026

(54) LANGUAGE MODELS FOR SPATIAL SOUND SYNTHESIS

(71) Applicant: NVIDIA Corporation, Santa Clara, CA (US)

(72) Inventors: Jonathan Lorraine, Toronto (CA); Jessie Richter-Powell, Toronto (CA); David Jesus Acuna Marrero, Toronto (CA); Sanja Fidler, Toronto (CA)

(73) Assignee: NVIDIA Corporation, Santa Clara, CA (US)

(21) Appl. No.: 19/056,331

(22) Filed: Feb. 18, 2025

(51) Int. Cl. H04S 7/00; G06V 20/40

(52) U.S. Cl. CPC H04S 7/305; G06V 20/41; H04S 2400/11

(57) ABSTRACT

In various examples, systems and methods are disclosed relating to implementing language models for spatial sound synthesis. A system can identify a scene comprising at least one object or environmental feature. The system can determine, using a language model, a selection of an audio sample for the at least one object or environmental feature. The system can generate an updated scene including the audio sample associated with the at least one object or environmental feature.

### BACKGROUND

Three-dimensional (3D) scenes may be used in a variety of contexts, including but not limited to gaming applications, virtual reality (VR) applications, or design applications, among others. Conventional approaches for generating 3D scenes are limited in their ability to automatically incorporate audio elements, particularly spatially varying sounds.

### SUMMARY

Generative artificial intelligence models, such as language models, can be used to generate simulated three-dimensional scenes from input text prompts. However, conventional approaches for scene generation do not generate or provide any sound for the scene or objects/features placed therein. These existing techniques are limited to generating visual elements based on input text prompts, and they lack the capability to produce audio content that complements the visual elements. Although separate approaches exist for generating audio, such techniques are only capable of generating audio given text input or video input, and they do not integrate audio generation for a simulated/generated 3D scene.

To address these deficiencies, the techniques described herein utilize a language model to generate spatially varying sounds for objects and/or environmental features within a simulated scene. For example, a language model can be used to automatically generate commands to identify and select audio samples from a sound bank or generate audio samples using a generative audio machine-learning model, such as an audio diffusion model. The audio samples are then positioned within the scene to simulate the emission of sound from the corresponding objects or environmental features. During the simulation of the scene, the audio samples are rendered into a multi-channel audio output, creating spatial sound within the simulated scene. Such approaches extend the capabilities of conventional approaches to scene generation, which are incapable of automatically generating scenes with simulated spatial audio.

At least one aspect relates to one or more processors. The one or more processors can include one or more circuits. The one or more circuits can identify a one or more attributes of a scene (e.g., scene for which spatial audio is to be generated/selected) comprising at least one object or environmental feature that may emit audio (e.g., as active or ambient sound) based on one or more representations of the scene (e.g., one or more images depicting the scene, one or more interactive 3D simulations of the scene, etc.). The one or more circuits can determine, using a language model, a selection of an audio sample for the at least one object or environmental feature based on at least one attribute of the one or more attributes. The one or more circuits can generate at least one updated representation of the scene, the at least one representation including the audio sample associated with the at least one object or environmental feature.

In some implementations, the one or more circuits can determine, using the language model, a (e.g., 3D) position (location, pose, orientation, etc.) within the scene corresponding to emission of the audio sample based at least on a corresponding position of the at least one object or environmental feature (e.g., to place audio according to a corresponding object/feature, such as proximate to the object/feature). In some implementations, the one or more circuits can store (e.g., in a databank) a plurality of audio samples in association with corresponding metadata (e.g., metadata describing each sample). In some implementations, the one or more circuits can generate the selection of the audio sample by providing the metadata as input to the language model. In some implementations, the metadata comprises a respective text description of one or more (e.g., one, some, or each) of the plurality of audio samples. In some implementations, the one or more circuits can receive an input prompt identifying at least one attribute of the scene. In some implementations, the one or more circuits can generate the selection of an audio sample for the at least one object or environmental feature based at least on the input prompt.

In some implementations, the one or more circuits can determine, using the language model, an instruction to generate the audio sample according to the at least one attribute of the scene. In some implementations, the one or more circuits can generate the selection of the audio sample by providing the instruction as input to a machine-learning model (e.g., a generative AI model) updated (e.g., trained, retrained, fine-tuned, conditioned, etc.) to generate audio samples. In some implementations, the machine-learning model comprises an audio diffusion model. In some implementations, the one or more circuits can simulate the updated scene (e.g., render/simulate one or more representations of the scene, for instance in a game application) including the audio sample using at least one spatial audio function. In some implementations, the one or more circuits can generate the updated scene (e.g., including audio) in response to an interaction within an interactive application.

At least one aspect relates to a system. The system can include one or more processors. The system can determine, using a language model, a position at which sound associated with an object or environment feature is to be emitted within a three-dimensional (3D) scene. The system can generate, using a machine-learning model, an audio sample for a three-dimensional scene. The system can update the scene to include the audio sample at the position. The system can provide the 3D scene and the audio sample for presentation.

In some implementations, the system can determine the position within the 3D scene by providing at least one rendering of the 3D scene as input to the language model. In some implementations, the machine-learning model is an audio diffusion model. In some implementations, the machine-learning model is the language model and comprises a multimodal language model updated to generate audio data. In some implementations, the system can generate the audio sample further based on a text input (e.g., input received responsive to a prompt) that specifies an attribute of the 3D scene. In some implementations, the system can provide the audio sample for presentation using at least one spatial audio function. In some implementations, the system can determine, using the language model, at least one attribute of the audio sample. In some implementations, the system can generate the audio sample using the machine-learning model and the attribute.

At least one aspect is related to a method. The method can include identifying, using one or more processors, a scene comprising at least one object or environmental feature based on one or more representations of the scene. The method can include determining, using the one or more processors and a language model, a selection of an audio sample for the at least one object or environmental feature. The method can include generating, using the one or more processors, at least one updated scene representation of the scene, the at least one updated representation including the audio sample associated with the at least one object or environmental feature.

In some implementations, the method can include determining, using the one or more processors and the language model, a position for the audio sample within the scene based at least on a corresponding position of the at least one object or environmental feature.

The processors, systems, and/or methods described herein can be implemented by or included in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing generative AI operations using a large language model, a system for performing generative AI operations using a video language model, a system implemented using an edge device, a system implemented using a robot, a system for performing conversational AI operations, a system for generating synthetic data, a system incorporating one or more virtual machines (VMs), a system using or deploying one or more inference microservices, a system that incorporates one or more machine learning models deployed in a service or microservice along with an operating system (OS)-level virtualization package (e.g., a container), a system implemented at least partially in a data center, or a system implemented at least partially using cloud computing resources.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present systems and methods for implementing language models for spatial sound synthesis are described in detail below with reference to the attached drawing figures, wherein:

FIG. 1 is a block diagram of an example system for implementing language models for spatial sound synthesis, in accordance with some embodiments of the present disclosure;

FIG. 2A depicts an example data flow diagram showing how three-dimensional scenes can be rendered into various views for implementing the spatial sound synthesis techniques described herein, in accordance with some embodiments of the present disclosure;

FIG. 2B depicts an example data flow diagram showing how views (e.g., generated according to the data flow diagram of FIG. 2A) are used to select or generate audio samples to implement the spatial sound synthesis techniques described herein, in accordance with some embodiments of the present disclosure;

FIG. 3 is a flow diagram of an example of a method for implementing language models for spatial sound synthesis, in accordance with some embodiments of the present disclosure;

FIG. 4A is a block diagram of an example generative language model system suitable for use in implementing at least some embodiments of the present disclosure;

FIG. 4B is a block diagram of an example generative language model that includes a transformer encoder-decoder suitable for use in implementing at least some embodiments of the present disclosure;

FIG. 4C is a block diagram of an example generative language model that includes a decoder-only transformer architecture suitable for use in implementing at least some embodiments of the present disclosure;

FIG. 5 is a block diagram of an example computing device suitable for use in implementing at least some embodiments of the present disclosure; and

FIG. 6 is a block diagram of an example data center suitable for use in implementing at least some embodiments of the present disclosure.

### DETAILED DESCRIPTION

This disclosure relates to systems and methods for generating spatially varying audio for simulated scenes using output from one or more machine-learning languages, such as vision language models (VLMs). Simulated three-dimensional (3D) scenes can be generated using a variety of techniques, including generative techniques that generate 3D scenes from input text prompts. Such approaches can rely on language models to automatically generate attributes that define the properties of the simulated scene.

For example, approaches for generating 3D scenes can implement machine-learning models to automatically generate layouts that match a description provided in an input text prompt. These existing techniques for scene generation may use language models to automatically place objects and/or lighting at predicted positions determined based on the description in the input prompt. The relative positions of different objects may be modified/optimized or otherwise modified according to a placement algorithm to satisfy user-provided constraints for the 3D scene.

However, conventional approaches for scene generation do not generate or provide any sound for the scene or objects/features placed therein. Although approaches for generating audio exist, such techniques are only capable of generating audio given text input or video input, and do not generate audio for a simulated/generated 3D scene. Moreover, fewer approaches implement generation of spatially varying sounds, and even then, such approaches only operate in restricted domains and do not allow flexible conditioning via text input.

To address the deficiencies of conventional approaches, the techniques described herein use a language model to generate spatially varying sounds for objects and/or environmental features of a simulated scene. To do so, the language model can generate commands/instructions to identify and select audio samples for a scene. In one example, the language model can generate instructions to select one or more spatial audio samples from a sound bank for each object/environmental feature of a scene. In another example, the language model may generate instructions to automatically generate audio samples for each object/environmental feature of a scene using a generative audio machine-learning model, such as an audio diffusion model.

Audio samples selected or generated for a scene can then be associated (mapped or encoded with) objects or features that are placed/positioned within the scene such that the audio sample is simulated to be emitted from the object and/or environmental feature to which it corresponds. Audio samples within the scene can be rendered into a multi-channel audio output during simulation of the scene. For example, the audio samples can be modeled as audio sources that are rendered simultaneously during scene simulation according to an audio rendering function. Using these techniques, language models can be used to automatically generate spatial audio for 3D scenes based at least on text input.

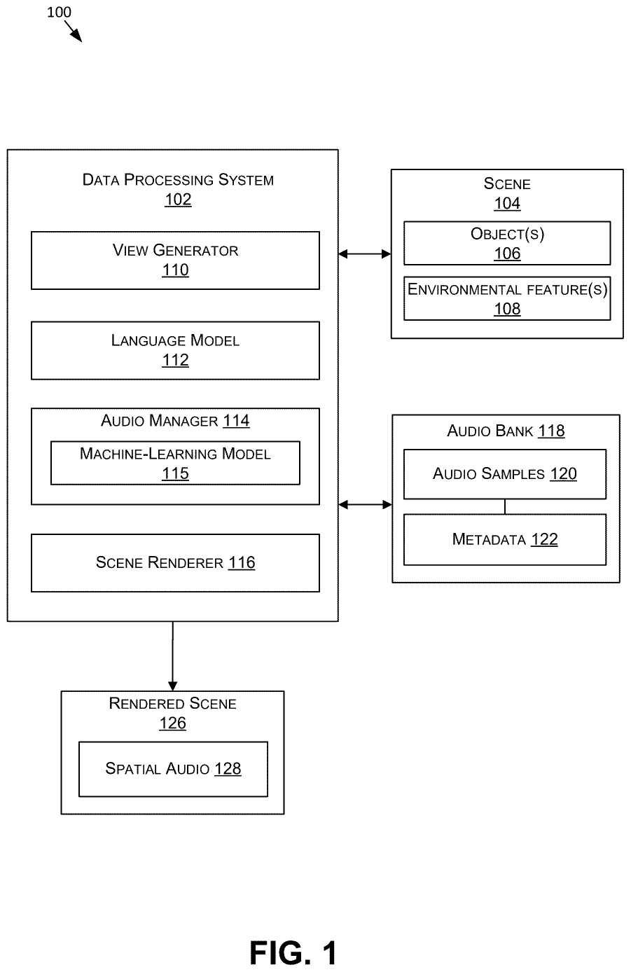

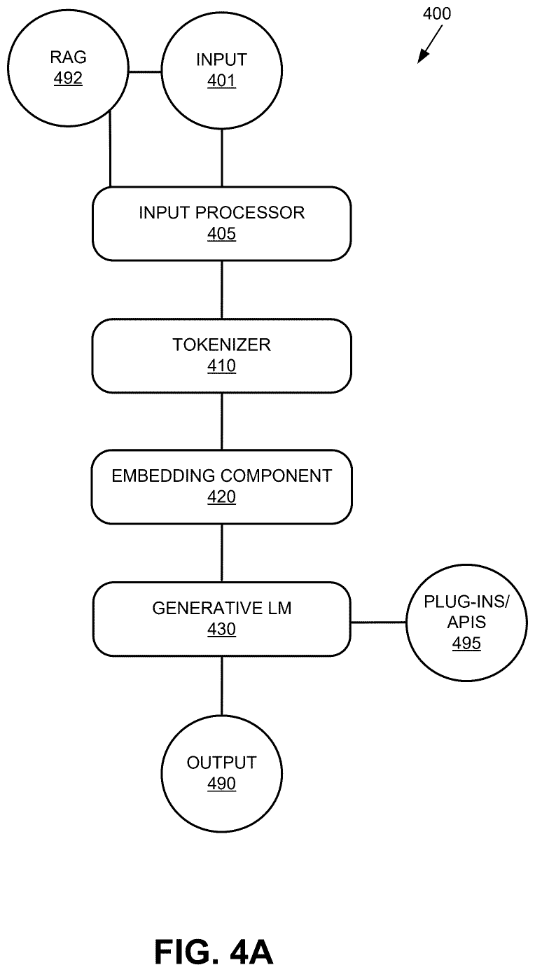

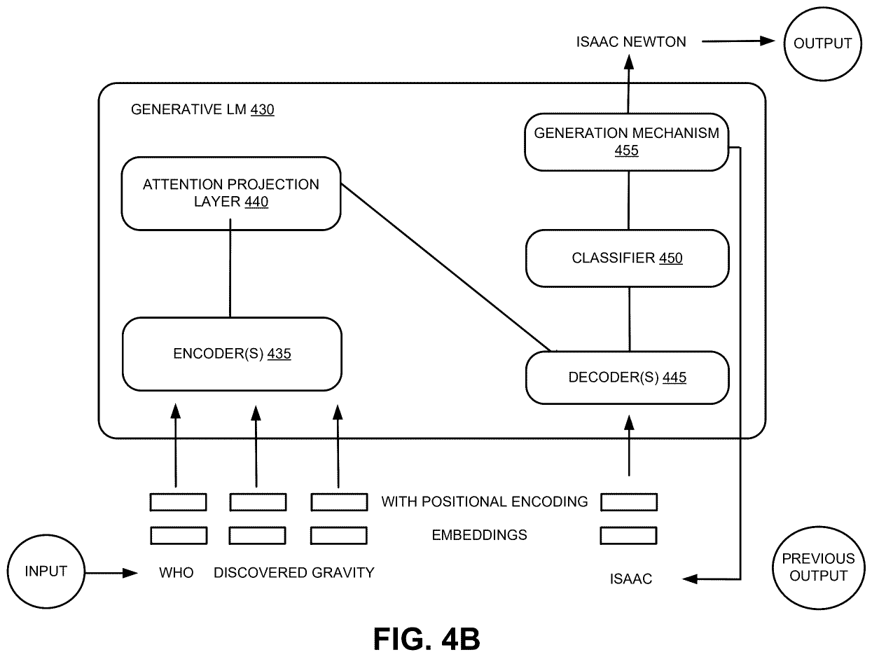

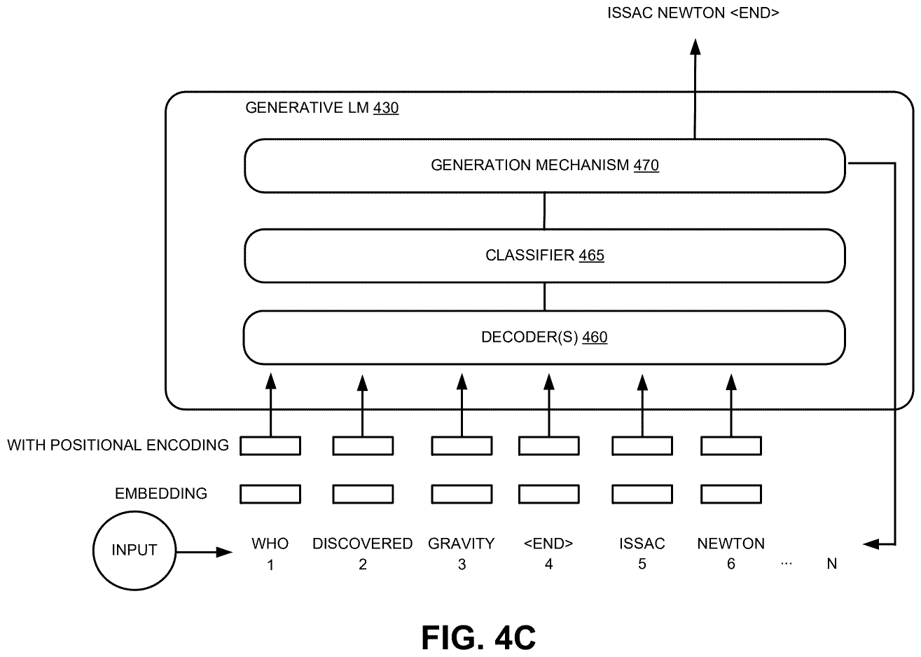

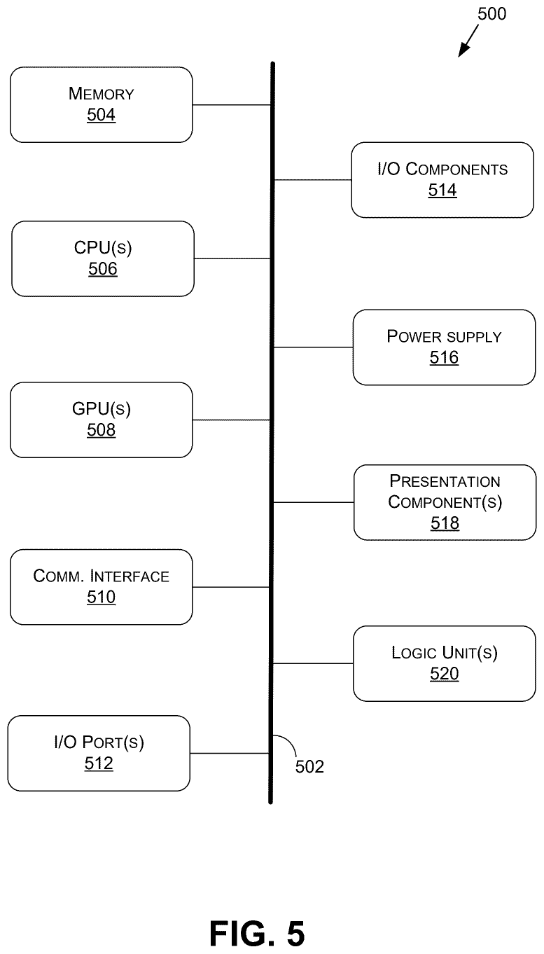

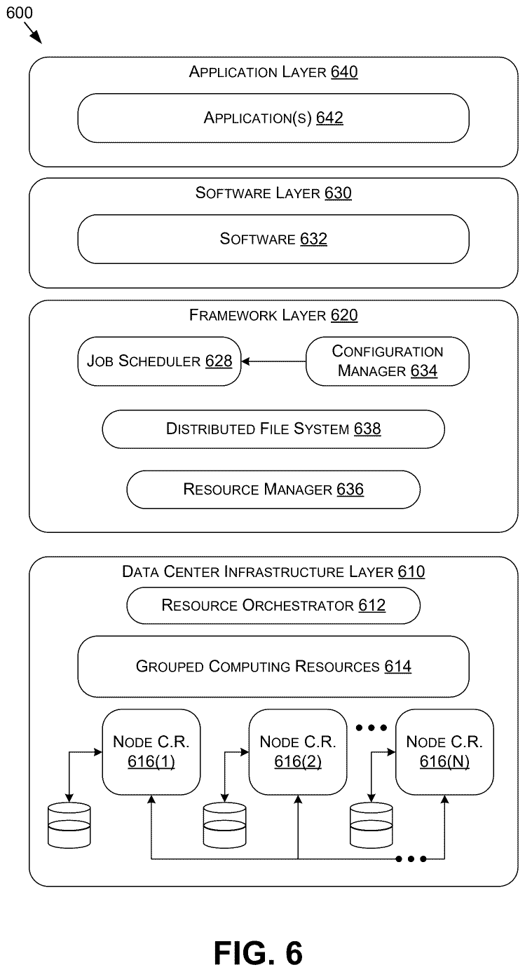

With reference to FIG. 1, FIG. 1 is an example computing environment including a system for implementing language models for spatial sound synthesis, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. For example, in some embodiments, the system and methods described herein may be implemented using one or more generative language models (e.g., as described in FIGS. 4A-4C), one or more computing devices or components thereof (e.g., as described in FIG. 5), and/or one or more data centers or components thereof (e.g., as described in FIG. 6).

The system 100 can be used to automatically select and/or generate contextually appropriate spatial audio 128 for simulated scenes 104, which can be provided as part of a rendered scene 126. The system is shown as including a data processing system 102, at least one scene 104, an audio bank 118, and at least one rendered scene 126. The data processing system 102 is shown as implementing a view generator 110, a language model 112, an audio manager 114, and a scene renderer 116. The scene 104 can be a simulated three-dimensional scene that may include one or more objects 106 and/or environmental features 108. The audio bank 118 is shown as storing one or more audio samples 120 in association with corresponding metadata 122. In some implementations, the data processing system 102 may receive input prompts to guide selection/generation of audio samples 120 for the scene 104, as described in further detail herein. The rendered scene 126 can be generated by the scene renderer 116 using corresponding selected/generated audio samples 120, such that the rendered scene 126 includes spatial audio 128 rendered according to a spatial audio function.

The data processing system 102 can include one or more processors, circuits, memory, and/or computing devices/systems that can perform the various techniques described herein. The data processing system 102 can be implemented, for example, in a cloud computing environment, which may maintain, update, and/or execute one or more language models 112 and/or machine-learning model(s) 115. The data processing system 102 can implement the various techniques described herein to automatically process simulated scenes 104 to select/generate audio samples 120 for inclusion in the scene 104, including predicting positions and/or other parameters for the selected/generated audio samples 120.

In this example, both the scene 104 and the audio bank 118 are shown as separate from the data processing system 102. In such implementations, the scene 104 and/or the audio bank 118 can be stored via a storage. The storage may be or include an external server, distributed storage/computing environment (e.g., a cloud storage system), or any other type of storage device or system that is in communication with the data processing system 102. Although shown in this example as being external to the data processing system 102, it should be understood that the scene 104 and/or the audio bank 118 may form a part of, or may otherwise be stored internal to, the data processing system 102.

The scene 104 can include a simulated, three-dimensional (3D) environment including 3D models (e.g., the objects 106, etc.) having various positions, attributes, textures, or other features. The scene 104 may also include various environmental features 108, which may include metadata, lighting information (e.g., position and attributes of one or more light sources, etc.), or various other properties described herein. In one example, the scene 104 may be generated using generative artificial intelligence models, which may include one or more language models or other types of machine-learning models that output various properties, objects, or other aspects of the three-dimensional scene 104. One example of a scene 104 may include a three-dimensional room, which may include objects 106 or environmental features 108 that could serve as source(s) of sound. In another example, the scene 104 may be provided as part of an application executing at, or in communication with, the data processing system 102. For example, the applications may include 3D gaming applications, 3D modeling applications, or other types of 3D applications that involve the generation and/or rendering of a 3D scene 104.

The scene 104 can include one or more objects 106. The simulated scene 104 can include any number of objects 106. Objects 106 within a simulated scene 104 can be positioned at any location, pose, orientation, etc. within the scene 104 and may have any 3D orientation. Objects 106 may be placed in the scene 104 during scene generation, in some implementations. The objects 106 can include 3D models, texture data, or other information that may be used to render the objects 106. The objects 106 can include 3D mesh assets, which may represent any type of object, entity, or graphical feature within the scene 104. Objects 106 may include additional assets/data that correspond to the visual characteristics of the objects 106, including but not limited to textures, materials, or patterns, among other assets.

The objects 106 can include or may be stored in association with metadata indicating various characteristics of the object. The metadata may indicate the type of object 106, qualities of the object 106, indications of whether sound is to be selected/generated for the object 106, position information indicating the three-dimensional position of the object 106 within the scene 104, and/or any other attribute of the object 106. In one example, an object 106 may be an object 106 that could emit/cause/generate/output noise or sound in an environment, such as a fan or a radio, among others. Some objects 106 in a scene 104 may be objects 106 that do not typically emit sound, such as tables, chairs, or photographs. The data processing system 102 can implement the techniques described herein to automatically select and/or generate audio samples 120 for objects 106 within a scene 104.

The scene 104 may include one or more environmental features, which may be features of the scene 104 that provide context or realism within the scene 104 that are not necessarily objects. Environmental features 108 can encompass a wide range of elements, such as lighting, atmospheric conditions, and background elements. For example, environmental features 108 of a scene may include atmospheric conditions of the scene 104 that may or may not typically be associated with ambient sound, such as the presence of fog, rain, or wind.

In another example, the environmental features 108 can include background elements that provide additional context and realism to the scene 104. For example, the scene 104 can include a simulated forest environment, where the environmental features 108 can include indications of a type of background provided within the scene (e.g., high density of trees, presence or absence of birds or other animals, etc.). Each of these background elements can be associated with corresponding positions and/or regions within the scene 104, as specified in metadata associated with the environmental features 108. The environmental features 108 may include information corresponding to other types of environments, such as traffic-dense streets, the presence of a highway or road in the scene 104, or other types of background elements.

The environmental features 108 can include or be stored in association with corresponding metadata, which may include or specify attributes of the environmental features such as position, size, or other descriptive qualities. The descriptive qualities of the environmental features 108 may include text data describing properties of the environmental features 108 and/or other attributes of the scene in natural language. The data processing system 102 can use the metadata associated with the objects 106 and/or environmental features 108 to automatically select/generate audio samples 120 for placement within the scene 104. In some implementations, the environmental features 108 may include an object 106 or group of objects 106 within the scene 104, with the metadata specifying position information and the environmental feature 108 to which the object(s) 106 correspond.

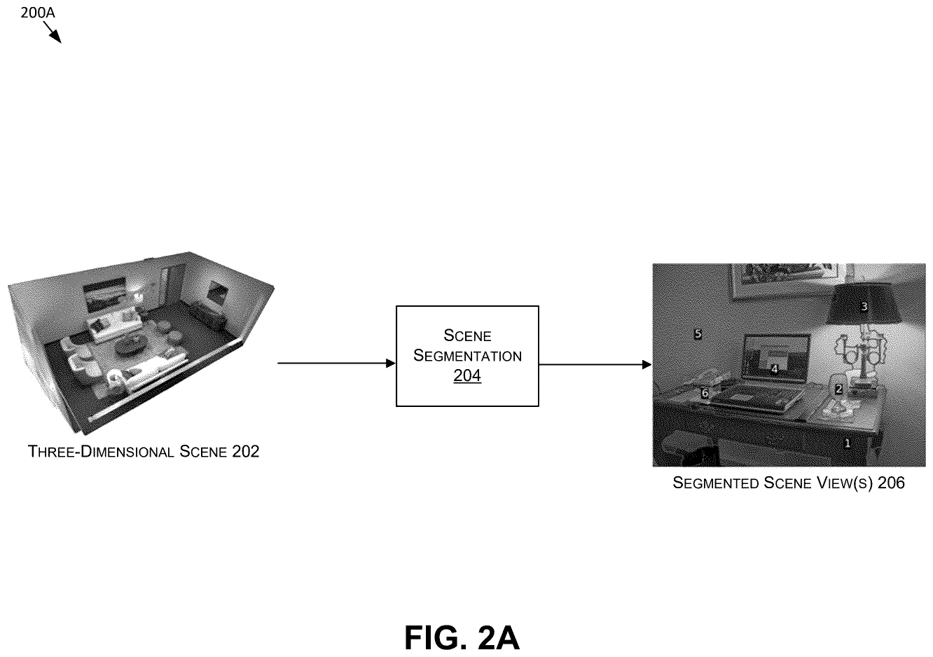

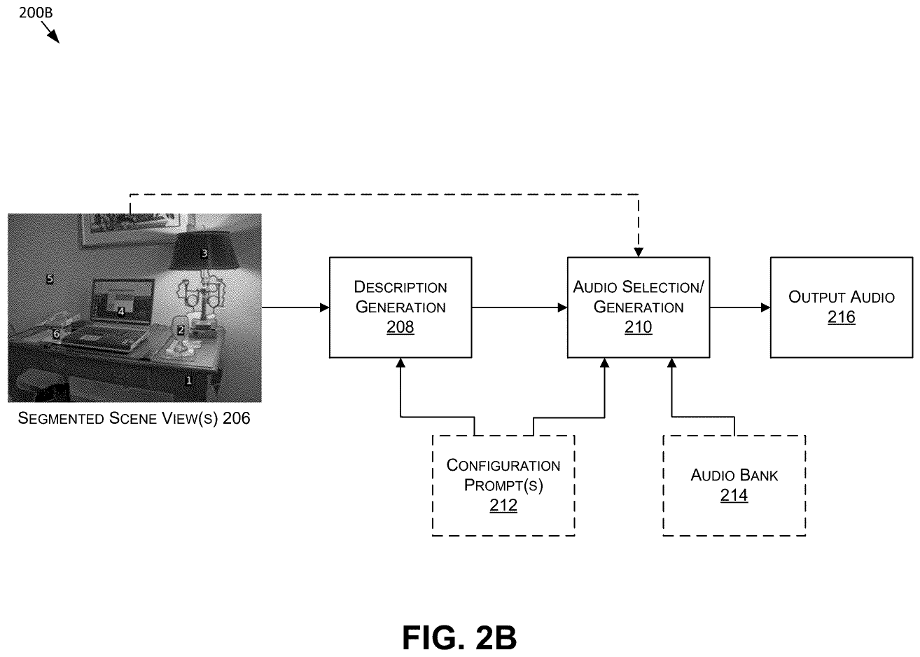

The data processing system 102 can perform the various techniques described herein to select/generate audio samples 120 for inclusion at the scene 104 to simulate realistic spatial audio. In some implementations, the data processing system 102 can generate one or more renderings (e.g., segmented scene views 206 of FIG. 2A) of the scene 104 and provide the renderings as input to one or more language models 112. In such implementations, the language models 112 may include vision language models, which can receive multimodal input (e.g., text data, image data, etc.) as input and generate text information as output. For example, the language model 112 may be trained/updated to process image data to classify various attributes of objects 106 and/or environmental features 108 represented in the renderings of the scene 104.

To generate renderings of the scene 104, the data processing system 102 can execute the view generator 110. The view generator 110 can include software, hardware, or combinations of hardware and software. The view generator 110 can render the scene 104 according to various different viewpoints. To do so, the view generator 110 can access and store the data of the scene 104 in memory of the data processing system 102 and can generate/instantiate a virtual camera within the geometry of the scene 104. The position of the camera can be selected using a variety of techniques, to capture different views of the scene 104.

In some implementations, the view generator 110 can generate a set of predetermined views, including views such as a top-down view, a perspective view, and/or a side view, among others, to ensure that all objects 106 and/or environmental features 108 in the scene 104 are completely represented in the rendered views. In some implementations, the view generator 110 can dynamically determine the viewpoints (e.g., position and orientation of the camera) based on the positions/orientation of objects 106 and/or environmental features 108 present in the scene 104. For example, if the scene 104 includes a complex arrangement of objects 106, such as a cluttered room with multiple furniture items, the view generator 110 can generate a series of views that ensure each object 106 is adequately represented in at least one rendering of the scene 104.

To determine the position/orientation of the camera to render the scene 104, the view generator 110 can analyze the metadata associated with each object 106 and/or environmental feature 108 to identify the position, orientation, or other visibility information (e.g., size, dimensions, etc.), and can automatically generate select/generate respective positions/orientations for the camera such that the camera captures the objects 106 and/or environmental features 108 from optimal angles. The view generator 110 can then automatically place the camera within the scene according to the position/orientation for each view and can render the scene using a suitable rendering process. In some implementations, the view generator 110 may generate one or more panoramic renderings of the scene 104, to capture the scene 104 in a single panoramic view. An example dataflow diagram showing how two-dimensional (2D) renderings can be generated from a 3D scene are shown in FIG. 2A.

Referring to FIG. 2A, depicted is an example data flow diagram 200A showing how 3D scenes 202 (e.g., a scene 104) can be rendered into different scene views 206 for implementing the spatial sound synthesis techniques described herein, in accordance with some embodiments of the present disclosure. As shown, in this example, the 3D scene 202 is provided to a scene segmentation process 204, which can include performing the operations of the view generator 110 of FIG. 1. The scene segmentation process 204 can include generating or selecting a set of poses for a camera to position within the scene to generate a set of segmented scene views 206.

In this example, the 3D scene 202 is an example depiction of a living room including furniture (e.g., objects 106) such as couches, chairs, and cabinets, as well as different decorations (e.g., objects 106) such as mirrors and paintings. The 3D scene 202 is represented as a perspective view with the wall closest to the viewer being made invisible for ease of visualization. Any number of segmented scene views 206 can be generated to represent the objects and/or environmental features in the 3D scene 202. In this example, the segmented scene view 206 shows a desk with a laptop, a lamp, and a glass in front of a wall. As shown, each item is represented with a corresponding segmentation (indicated by a color overlay) and an annotation (indicated by a number). In some implementations, the annotation may be added to the segmented scene view 206 after generating the segmentations to specify approximate positions of different objects/features in the view 206. The annotations can facilitate placement of audio samples within the scene 202. Although not shown here, additional segmented scene views 206 can be generated using the scene segmentation process 204 to represent the other objects in the 3D scene 202.

The segmented scene views 206 can be or include 2D image(s) that represent a view of the scene 104 from a corresponding viewpoint. Any suitable rendering process can be used to generate the scene, including ray tracing to simulate the interaction of light with objects and/or environmental features in the 3D scene 202. The rendering process used can be a realistic rendering process, such that a vision language model (e.g., the language model 112) can accurately detect and classify the objects represented in the segmented scene views 206. Once generated, the segmented scene views 206 can be used in connection with one or more language models to select and/or generate audio samples to simulate spatial audio in the 3D scene, as described in further detail herein.

Referring back to FIG. 1, once generated, the view generator 110 can store each of the segmented views of the scene 104 in memory of the data processing system 102. In some implementations, one or more of the segmented views of the scene 104 can be stored in association with one or more identifiers of objects 106 and/or environmental features 108 represented in the segmented views of the scene 104. In some implementations, identifiers or metadata for the objects 106 and/or environment features 108 may not necessarily be available or stored in association with the segmented views. In such implementations, one or more (e.g., one, some, or each) of the segmented views of the scene 104 can be stored in a corresponding view identifier.

The data processing system 102 can execute one or more language models 112 using the segmented views of the scene 104 and/or metadata of the objects 106, environment features 108, or the scene 104 as input to select/generate audio samples 120 for the scene 104. The language model 112 can be any type of machine-learning model that is capable processing natural language input. In other implementations, the language model 112 can be a text-based model, which processes text input data such as input prompts, natural language instructions, or structured data (e.g., metadata 122 corresponding to one or more audio samples 120). Such text-based language models 112 may include a transformer-based architecture, such as a generative pre-trained transformer (GPT) architecture, that is trained/updated to understand and generate natural language text, structured data, or other types of text-based input.

In some implementations, the language model 112 can be a multi-modal model, such as a VLM that can process text, images, and/or other multi-modal inputs. In such implementations, the language model 112 can be trained/updated to understand and interpret visual content (e.g., images, segmented views of the scene 104) as well as text content (e.g., input prompts, input instructions in natural language format, etc.) simultaneously. For example, a text prompt may include instructions (e.g., a configuration/system prompt, etc.) for the language model 112 to classify and/or determine attributes of different objects 106 and/or environmental features 108 represented in an input image (e.g., a segmented view of the scene 104), or in some implementations, to select audio samples 120 to be placed in the scene 104 with one or more objects 106 and/or environmental features 108, according to the techniques described herein.

In this example, the language model 112 is represented as internal component of the data processing system 102 and can be stored and executed locally. However, it should be understood that in some implementations, the language model 112 can be external to the data processing system 102. For example, the language model 112 may be accessible via a network connection to a remote server or distributed computing system. In implementations where the language model 112 is stored externally, the data processing system 102 (or the components thereof) can communicate with the language model 112 through an application programming interface (API) to send input data and receive processed outputs.

The data processing system 102 can execute the audio manager 114 to select and/or generate one or more audio samples 120 for the scene 104. The audio manager 114 may include software, hardware, or combinations thereof. In one example implementation, the audio manager 114 can use the language model 112 to select one or more audio samples 120 from the audio bank 118 to be placed within the scene 104 at positions that correspond to sound-emitting objects 106 or environmental features 108. To select the audio samples 120, the audio manager 114 can access the audio bank 118 to retrieve metadata 122 associated with the audio samples 120 stored therein.

The audio bank 118 can be a storage system, storage repository, or data structure that can store and/or maintain a set of audio samples 120 and corresponding metadata 122. In this example, the audio bank 118 is represented as external to the data processing system 102 and may be accessible via network communications and/or APIs. However, it should be understood that in some implementations, the audio bank 118 can be internal to the data processing system 102 and stored within a memory or data repository of the data processing system 102. The audio bank 118 can store any number of audio samples 120 and associated metadata 122 and may be updated or managed by the data processing system 102 or other external computing systems.

The audio bank 118 is shown as storing a set of audio samples 120. The audio samples 120 can include any number of audio files in varying formats that encode a variety of sound recordings, such as environmental sounds, object-specific sounds, and ambient noises. In one or more embodiments, an (e.g., some, each, etc.) audio sample 120 of the set of audio samples may have a respective duration, encoding/codec, and association to corresponding metadata 122. The audio samples 120 may include monophonic audio samples, stereo audio samples, or audio samples stored in a spatial audio format (e.g., B-format audio, etc.). Examples of audio samples 120 can include but are not limited to recordings of ambient noise from objects such as fans, televisions, or refrigerators/appliances, or recordings of ambient noises such as wildlife, wind, rain, or traffic/road noise, among others.

The audio samples 120 are shown as being stored in association with corresponding metadata 122. The metadata 122 can include text data that provides a descriptive caption for the audio sample 120 to which it corresponds. The metadata 122 associated with an audio sample 120 can include descriptive information such as the type of sound, the type of object that emitted/generated/corresponds to the recorded sound, and any additional parameters that can facilitate accurate placement and rendering of the audio sample 120 within the scene 104. The metadata 122 can include tags or identifiers that can be used to retrieve of the audio samples 120 from the audio bank 118 for inclusion in the scene 104.

In implementations where the language model 112 includes a VLM, the audio manager 114 can use the language model 112 to select audio samples 120 for inclusion in the simulated scene 104 using the segmented views of the scene generated by the view generator 110. The audio manager 114 can generate one or more input data structures for the language model 112 that include segmented views of the scene 104 and metadata 122 from the audio bank 118. As described herein, the segmented views of the scene 104 can provide a visual representation of the scene 104 from one or more different perspectives (e.g., a top view, a perspective view, etc.). The input data structure(s) can include text instructions that specify how the language model 112 is to process the segmented views. In some implementations, a single segmented view can be provided as input to the language model 112 at a time (e.g., for a single execution iteration). In some implementations, multiple segmented views of the same scene 104 can be provided as input to the language model 112 at the same time (e.g., during the same execution iteration).

The audio manager 114 can provide text-based instructions to the vision language model to process the generated views of the scene 104 to identify and describe different objects 106 and/or environmental features 108. For example, the language model 112 can be executed (by the data processing system 102 and/or an external computing system, depending on the implementation) to generate an output message that includes text-based description(s) of the scene 104 generally and of different objects 106 or environmental features 108 represented in the views of the scene 104. The descriptions may include classifications (e.g., type of object 106 and/or environmental feature), attributes (e.g., size, descriptive qualities, etc.), or position information, such as estimated coordinates of where sound is to be emitted/generated by the object 106 and/or environmental feature 108 when the scene 104 is rendered. In some implementations, the description information may be generated only for objects 106 and/or environmental features 108 that are likely to emit/generate sound in a realistic simulation. In some implementations, the description information may be generated for (only) objects 106 and/or environmental features 108 identified within the scene 104.

The audio manager 114 can execute the language model 112 as a component of the data processing system 102 or may provide the instructions and/or view segments to the language model using a corresponding API call. The descriptions generated by the language model 112 can be used by the audio manager 114 to select and/or generate audio samples 120 for inclusion in the scene 104. For implementations in which the audio manager 114 selects audio samples 120 from the audio bank 118, the audio manager 114 can access the description information generated by the VLM and the metadata 122 associated with audio samples 120 to generate an input data structure for a language model 112. In some implementations, the data processing system 102 can maintain/store/execute, or otherwise be in communication with, multiple language models 112. For example, the data processing system 102 may execute a first language model 112 to classify/generate descriptions for segmented views of a scene 104 and execute a second language model 112 to select audio samples 120 according to the techniques described herein. In some implementations, the audio manager 114 can access a single language model 112 to perform both generation of description information and selection of audio samples 120, with each operation implementing different input data structures and instructions (e.g., configuration/system prompts, etc.).

To generate the input data structure for the language model 112, the audio manager 114 can retrieve descriptive tags and/or text information, as well as corresponding identifiers of each audio sample 120 from the metadata 122 in the audio bank 118. The data structure can be generated to include the metadata 122 in a structured format, such that the language model 112 can associate descriptive text information of an audio sample 120 with its corresponding identifier. The audio manager 114 can generate the input data structure in a structured format that associated the description information for each object 106 and/or environmental feature 108 with a corresponding identifier of each object 106 and/or environmental feature 108. The input data structure may be generated to include instructions that specify that the language model 112 is to select at least one identifier of an audio sample 120 for each object 106 and/or environmental feature 108 within the scene that is likely to emit/generate sound. The instructions may be provided as natural language text input as part of a configuration/system prompt, in some implementations.

In some implementations, the input data structure may be generated to include the segmented scene views generated by the view generator 110. In such implementations, the input data structure may store the descriptions of objects 106 and/or environment features 108 in association with the views from which the descriptions were derived as caption information. The instructions to process the text and image data can be provided as a system/configuration prompt that specifies the language model 112 is to process the views in connection with the description information to select corresponding identifiers of audio samples 120. In some implementations, the metadata 122 associated with audio samples can be provided as text input that is separate from the input views of the scene 104.

The audio manager 114 can provide the input data structure(s) to the language model 112 directly or within a transmission via an API request. The language model 112, when executed, can process the input data structure to generate an output message that associates identifiers of relevant audio samples 120 with corresponding positions within the scene 104. As the identifier of each audio sample 120 is provided in the input data structure with a corresponding text description (e.g., from the metadata 122), the language model 112 can automatically determine, using the provided description information of the objects 106 and/or environmental features 108 (and in some implementations, the segmented views of the scene 104), which audio samples 120 are to be rendered in association with corresponding objects 106 and/or environmental features 108. For example, if one object 106 in the scene 104 is a desk fan, and the audio bank 118 includes an audio sample 120 with metadata 122 specifying that the sample is a recording of a desk fan, the language model can automatically associate the identifier of the audio sample 120 of the recording of the desk fan with the object 106 identified (e.g., in the description information of the input data structure) as a desk fan.

The instructions may specify the language model 112 to generate an output message that includes a structured data format with identifiers of selected audio samples 120 provided in association with identifiers of corresponding objects 106. In some implementations, the output message can include a list of identifiers for the audio samples 120 with predicted coordinates for where each selected audio sample 120 is to be rendered within the scene 104. The coordinates can be determined based on the positions of the objects 106 and environmental features 108 in the segmented views. For example, if the language model 112 identifies a desk fan in the scene 104, the language model 112 can generate an output message that specifies the identifier of an appropriate audio sample 120 for the fan and the coordinates at which the audio sample 120 should be rendered.

In some implementations, the coordinates may be provided as two-dimensional coordinates that map to a corresponding pixel location within a corresponding view of the scene 104 (e.g., a top view). In such implementations, the audio manager 114 can automatically map the two-dimensional pixel coordinates to three-dimensional coordinates in the reference frame of the scene. The mapping may be a function of the position (e.g., location, pose, orientation), and field-of-view of the camera used to capture the corresponding view of the scene 104. In some implementations, the coordinates can be predicted in a three-dimensional coordinate system that corresponds to the reference frame of the scene 104.

In some implementations, the language model 112 can be a text-based language model (e.g., a large language model (LLM), etc.), and the audio manager 114 can select and/or generate audio samples 120 without using views of the scene 104 generated by the view generator 110. In such implementations, the audio manager 114 can provide text-based input to the language model 112 that includes structured data indicating the coordinates of the objects 106 and/or environmental features 108 of the scene 104, as well as metadata that provides a text-based description of the objects 106 and/or environmental features 108. The metadata may be provided as part of the scene 104 and may be stored in association with associated objects 106 and/or environmental features 108. Similarly to the vision language model described herein, the text-based language model 112 can be instructed by the audio manager 114 to select corresponding audio samples 120 (using audio sample metadata 122) that are likely to be emitted by corresponding objects 106 and/or environmental features 108. The output of the text-based language model 112 may be an output message that includes identifiers of objects 106 and/or environmental features 108 paired with identifiers of selected audio samples 120, as described herein.

In some implementations, as an alternative to or in addition to selecting audio samples 120 using the language model, the audio manager 114 can generate one or more audio samples 120 for corresponding objects 106 and/or environmental features 108 in the scene 104. To do so, the audio manager 114 can use a machine-learning model 115. The machine-learning model 115 can be any type of model that can generate audio output, including but not limited to an audio diffusion model. Although shown here as internal to the data processing system 102, in some implementations, the machine-learning model 115 may be external to the data processing system 102. In such implementations, the audio manager 114 can access functionality of the machine-learning model 115 using one or more corresponding API requests.

To generate relevant audio samples 120 for identified objects 106 and/or environmental features 108 in the scene 104, the audio manager 114 can use the description information of the objects 106 and/or environmental features 108, which are generated by the language model 112, as part of input prompts for the machine-learning model 115. In such implementations, the machine-learning model 115 can be an audio diffusion model trained/updated to generate sounds according to input instructions. The audio manager 114 can automatically generate an input prompt/input data structure for the machine-learning model 115 that instructs the machine-learning model 115 to generate realistic sounds for a given object. In some implementations, the description information may include a description of a type of sound that is to be emitted/generated by the corresponding object 106 and/or environmental feature 108.

Furthering the above example, if the language model 112 generates a description indicating that a specific object 106 is a desk fan, the audio manager 114 can provide the description as part of an input prompt to the machine-learning model 115 to generate an audio sample 120 that simulates the sound of a desk fan. The input prompt can include additional descriptive information, such as the type of fan (e.g., ceiling fan, desk fan), the size of the fan, and any other relevant attributes that can influence the characteristics of the generated audio sample 120.

In some configurations, configuration settings of the data processing system 102 and/or the description information of the objects 106 and/or environmental features 108 can specify the length or other characteristics of the generated audio samples 120. For instance, if the description indicates that the fan is in a room with a high ceiling, the audio manager 114 can instruct the machine-learning model 115 to generate an audio sample 120 that simulates the reverberation of the fan in a larger space. Alternatively, if the description specifies that the fan is in a small, enclosed space, the audio manager 114 can instruct the machine-learning model 115 to generate an audio sample 120 with less reverberation. Other characteristics that may be specified by the configuration settings and/or description information include volume/intensity of the audio sample 120 or temporal aspects of the audio sample 120, among others.

In some implementations, the audio manager 114 can use the machine-learning model 115 to generate audio samples 120 for objects 106 and/or environment features 108 that are not represented in the audio bank 118. For example, in some implementations, the language model 112 can generate in an output message associating identifiers of audio samples 120 with corresponding objects 106 and/or environment features 108. However, certain objects 106 and/or environment features 108 within the scene 104 may generate/emit sound, but a corresponding audio sample is not present in the audio bank 118 and therefore would not be selected using the language model 112. In such implementations, the language model 112 may output an indication that a corresponding sound is not present in the audio bank 118. In some implementations, the indication may include a description of the audio sample 120, which can be used by the audio manager 114 to instruct the machine-learning model 115 to generate a corresponding audio sample 120 to associate with the corresponding objects 106 and/or environment features 108.

In some implementations, the audio manager 114 can access additional input prompts to guide, configure, or otherwise generate instructions for selection and/or generation of one or more audio samples. The input prompt(s) can be received from one or more external computing systems, from internal configuration setting of the data processing system 102, and/or provided as input via an operator of the data processing system 102, among other sources. The input prompt(s) can indicate one or more attributes of the scene 104, and/or objects 106 and/or environmental features 108 therein. The input prompt(s) may specify one or more descriptive qualities of the scene 104, object(s) 106, and/or environmental features 108 that can instruct the language model 112 to select and/or generate audio samples that match those descriptive qualities. For example, an input prompt may indicate that a particular scene 104 is to involve very loud or clamorous sounds. The audio manager can generate and/or supplement the configuration/prompts of the input data structure(s) for the language model 112 and/or machine-learning model 115 to instruct the language model 112 and/or the machine-learning model 115 to use these attributes to select and/or generate audio samples 120 that match those qualities.

An example data flow diagram representing operations of the audio manager 114 is provided in FIG. 2B. Referring to FIG. 2B in the context of the components described in connection with FIGS. 1 and 2A, depicted is an example data flow diagram 200B showing how the views generated according to the data flow diagram of FIG. 2A are used to select or generate audio samples to implement the spatial sound synthesis techniques described herein, in accordance with some embodiments of the present disclosure. As shown, the segmented scene views 206 described in connection with FIG. 2A are provided as input to a description generation process 208. The description generation process 208 can include providing the segmented views 206 as input to one or more VLMs, with one or more corresponding configuration prompts 212 that can instruct the vision language model to describe, and in some implementations may predict coordinates for, objects 106 and/or environmental features 108. The configuration prompts 212 may be provided as text data in a system prompt or another type of input prompt that specify the descriptive output that is to be generated by the vision language model given the input segmented scene views 206.

The generated descriptions can then be provided to an audio selection/generation process 210. The audio selection/generation process 210 may involve selecting one or more audio samples (e.g., audio samples 120) from an audio bank 214 (e.g., the audio bank 118), and/or generating one or more audio samples, using the description information provided from the description generation process 208. The description information may include attributes such as a predicted position(s) of objects and/or environmental features detected in the segmented scene views 206, as well as classifications or other text-based description for each object and/or environmental feature in the segmented scene views 206.

As described herein, the audio selection/generation process 210 can select audio using a language model (e.g., using instructions from corresponding configuration prompt(s) 212) that generates associations between identifiers of audio samples and corresponding identifiers of objects and/or environmental features. In some implementations, an audio diffusion model may be used to generate corresponding audio samples, as described herein. The selected and/or generated audio samples can be provided as output audio 216, which may be stored in association with identifiers of objects and/or environmental features to which the selected/generated audio samples correspond and/or coordinate information at which the audio samples are to be placed within the scene.

Referring back to FIG. 1, once the audio samples 120 have been generated and/or selected, the audio manager 114 can provide the audio samples 120 and corresponding coordinate information to the scene renderer 116. The scene renderer 116 can update the scene 104 to include the selected/generated audio samples 120 by integrating the audio samples 120 at the coordinates of corresponding objects 106 and/or environmental features 108 predicted using the language model 112 and/or specified in metadata of the scene 104. For example, the scene renderer 116 can then map these audio samples 120 to their respective positions within the three-dimensional space of the scene 104, which may include updating the scene 104 to include an audio source object (e.g., without a corresponding three-dimensional mesh, etc.) that represents the audio sample 120 within the scene 104. The coordinates at which the audio samples 120 are placed may correspond to coordinates of the objects 106 and/or environmental features 108 within the scene, or audio emitting/generating portions thereof. For example, if the language model 112 predicted that a desk fan should emit sound at a specific position within the scene 104, the scene renderer 116 can place the corresponding audio sample 120 at that position, to simulate operation of the desk fan when the scene 104 is rendered.

The scene renderer 116 can render the scene 104 using a suitable three-dimensional rendering technique to generate the rendered scene 126. The scene 104 can be rendered, for example, using a suitable three-dimensional rendering technique, which may include implanting ray tracing rendering pipelines or similar rendering operations. The scene renderer 116 can render the scene 104 from the perspective of a virtual camera, which may have a corresponding position, orientation, and field-of-view. In addition to rendering visual elements of the scene 104, such as meshes, lighting, and effects, the scene renderer 116 can implement an audio rendering function to render the audio samples 120 into spatial audio 128. For example, the scene renderer 116 can render the audio samples 120 relative to the camera position. The scene renderer 116 can use a suitable spatial audio rendering technique to simulate the spatial positioning of the audio samples 120 within the scene 104, which can involve calculating the relative positions of the audio samples 120 with respect to the camera's viewpoint, which may vary as the camera moves within the scene 104.

In some implementations, the scene renderer 116 can apply algorithms that use the distance, direction, and orientation of the camera relative to each selected audio sample 120 when generating a realistic spatial audio 128 output. For instance, if the camera moves closer to a sound-emitting object corresponding to an audio sample 120, the scene renderer 116 can adjust the volume and spatial output of the audio sample 120 to reflect the change in proximity. In some implementations, the scene renderer 116 can simulate the effects of materials and/or environmental factors, such as reflections and reverberations, to further increase realism of the output spatial audio 128. The renderer scene 126 can be provided as output to a display of the data processing system 102 or another computing device (e.g., a client device) in communication with the data processing system 102. The spatial audio 128 can be provided via a suitable audio output device of the data processing system 102 or another computing device in communication with the data processing system 102.

In some implementations, the scene renderer 116 can update and render the scene 104 as part of an interactive application, including but not limited to a gaming application. In some implementations, interactions with the interactive application may cause a scene 104 to be accessed and/or generated for rendering into a rendered scene 126. Upon receiving an interaction to access/generate/render a scene 104, the data processing system 102 may automatically generate/select audio samples 120 for inclusion in the scene to simulate spatial audio 128, as described herein. Once selected/generated, the scene renderer 116 can automatically generate/render a corresponding rendered scene 126 and can simulate spatial audio 128 using a corresponding spatial audio function.

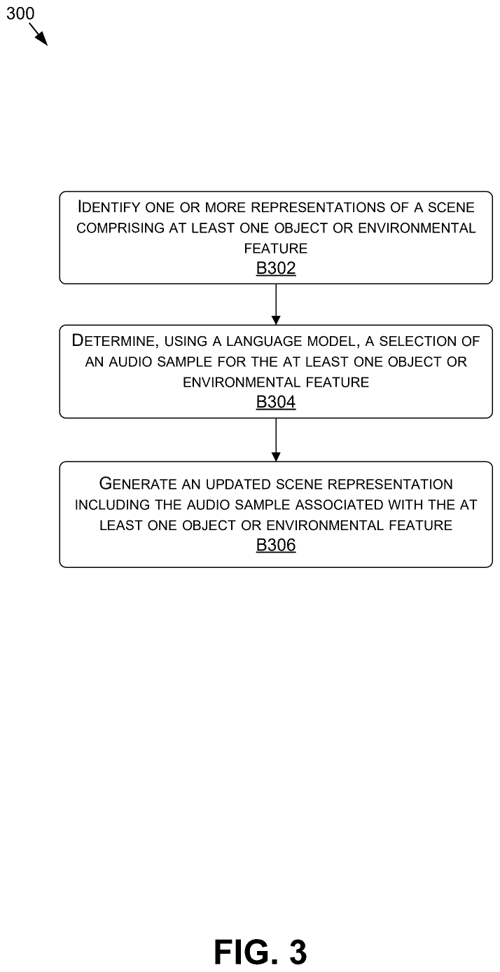

Now referring to FIG. 3, each block of method 300, described herein, includes a computing process that may be performed using any combination of hardware, firmware, and/or software. For instance, various functions may be carried out by one or more processors executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system of FIG. 1. However, this method may additionally or alternatively be executed by any one system, or any combination of systems, including, but not limited to, those described herein.

FIG. 3 is a flow diagram showing a method 300 for implementing language models for spatial sound synthesis, in accordance with some embodiments of the present disclosure. The method 300, at block B302, includes identifying one or more representations of a scene (e.g., a scene 104) comprising at least one object (e.g., objects 106) or environmental feature (e.g., environmental features 108). In some implementations, identifying a scene can include identifying one or more objects or environmental features present in one or more representations (e.g., one or more images, one or more embeddings, metadata associated with the scene, one or more values or parameters of a data structure or encoding, etc.) of the scene. In some implementations, identifying a scene can include identifying one or more attributes (e.g., features, characteristics, styles, genres, eras, values, elements, entities, etc.) associated with or depicted by the scene, or an identifier (e.g., an identifier value) to distinguish the scene from other scenes in a scene database. The scene can be generated by a generative artificial intelligence platform, provided via a three-dimensional modeling application, or received from an external computing system. In some implementations, the scene may be stored in memory of the computing system performing the method 300. The scene can include any number of objects, each of which may be associated with a respective set of coordinates (e.g., three-dimensional coordinates), metadata, and/or other information to render the object (e.g., mesh data, material data, etc.). Similar data corresponding to environmental features may also be stored in association with the scene.

The method 300, at block B304, includes determining, using a language model (e.g., the language model 112) a selection of an audio sample for the at least one object or environmental feature. In one example, the language model can be or include a vision language model that can receive one or more segmented scene views rendered from the scene. In such implementations, the scene can be rendered according to various viewpoints to generate a set of views, as described in connection with the view generator 110 of FIG. 1. The segmented views can be provided as input to the vision language model, which can generate descriptive information for various objects and/or environmental features detected in the scene. The description information may include location information (e.g., predicted or pixel coordinates at which the object and/or environmental feature appears in the scene), one or more attributes of the object and/or environmental feature (e.g., object type, object size, information relating to a type/quality of sound that may be emitted/generated by the object and/or environmental feature, etc.), and/or an identifier of the object and/or environmental feature, among other data.

The description information may be further processed by the language model using corresponding metadata (e.g., metadata 122) for different audio samples (e.g., audio samples 120) in an audio bank (e.g., audio bank 118). The metadata may be included in an input data structure for the language model with the generated description information for one or more views of the scene. As described herein, the metadata may include one or more attributes of the corresponding audio sample(s), including an identifier of the audio sample(s) and a natural language text-based description of the sound stored in the audio sample, among other information. In some implementations, the input data structure may also be generated to include the segmented views of the scene. The input data structure may be provided as input to the language model, which can automatically associate (e.g., select) identifiers of relevant audio samples with identifiers of objects and/or environmental features. The selected audio samples can be audio samples that the objects and/or environmental features are likely to emit in a realistic environment.

In some implementations, a text-based language model can be used to select audio samples, as described herein. For example, the language model may be an LLM that may not necessarily provide image-processing capabilities. In such implementations, the language model can process object description information that may be provided in connection with the scene and/or previously generated using a different vision language model. As described herein, the language model can automatically associate corresponding identifiers of audio samples and with objects and/or environmental features in the scene by matching description information. In some implementations, the description information may include position information (e.g., three-dimensional coordinates) of the objects and/or environmental features, which can be derived from the data of the scene, and the language model can automatically predict or otherwise generate placement coordinates for selected audio samples within the scene.

In some implementations, the audio samples can be generated using a machine-learning model (e.g., the machine-learning model 115). For example, rather than or in addition to selecting one or more audio samples, the description information of one or more objects and/or environmental features can be provided as input to an audio diffusion model to generate realistic simulated audio samples for the one or more objects and/or environmental features. In some implementations, audio samples may be generated for objects and/or environmental features that cannot be accurately matched to corresponding audio samples in the audio bank. In some implementations, audio samples may be generated for all objects and/or environmental features in the scene that are likely to emit sound in a realistic simulation.

In some implementations, additional input prompts may be used to guide and/or configure selection and/or generation of one or more audio samples. For example, one or more input prompts can be received that indicate one or more attributes of the scene and/or objects/environmental features therein. The input prompt(s) may specify a descriptive quality of the scene that can inform the language model to select and/or generate audio samples that match those descriptive qualities. For example, an input prompt may indicate that a particular scene is to involve very loud or clamorous sounds, and the language model can use these attributes to select audio samples that match those qualities.

The method 300, at block B306, includes generating an updated scene representation including the audio sample(s) associated with the at least one object and/or environmental feature. The scene representation can be updated by placing an object, such as an audio source object that identifies the audio sample, at corresponding predicted/generated coordinates of the scene representation (e.g., in a 3D simulation of the scene, in one or more images of the scene, as one or more values or parameters of a scene encoding, etc.). Updating the scene may include performing any of the operations of the scene renderer 116 described in connection with FIG. 1. In some implementations, the scene may be provided as part of an interactive application, such as a gaming application. In response to an interaction with the interactive application, the data processing system can automatically access the information for the scene and can select/generate audio samples for the scene to simulate spatial audio. Such techniques may be implemented in generative applications, where a scene is automatically generated in response to one or more conditions, and subsequently automatically populated with selected/generated audio samples to simulate realistic spatial audio.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational artificial intelligence (AI), light transport simulation (e.g., ray-tracing, path tracing, etc.), collaborative content creation for three-dimensional (3D) assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models such as one or more large language models (LLMs), systems for performing light transport simulation, systems for performing collaborative content creation for 3D assets, systems implemented at least partially using cloud computing resources, and/or other types of systems.

Approaches in accordance with various embodiments can be used to generate one or more parameters for a content generation environment. In at least one embodiment, a trained machine learning (ML) and/or artificial intelligence (AI) system, such as a large language model (LLM) or a vision language model (VLM), may be used to generate parameters for the content generation environment, such as, but not limited to, camera settings, scene lighting, video parameters, and/or the like, used for displaying objects within a scene. The parameters may be based on an input provided by a user or a proxy for a user to a trained language model (e.g., LLM, VLM, etc.) that can then generate one or more settings in accordance with the input. Various embodiments may be used to generate settings in two-dimensional (2D) or three-dimensional (3D) settings. For embodiments that incorporate one or more language models-that is, one or more LLMs, one or more VLMs, or a combination of LLMs and VLMs, the language model(s) may receive an input (e.g., a prompt, a request, a query, etc.) that is parsed or otherwise formatted to generate a deterministic output. For example, the input provided to the language model may include a particular format for the output results, an example of desired output results, a particular list of parameters and their respective formatting, and the like. An input generator (e.g., a prompt generator), which may be driven or otherwise guided by one or more AI and/or ML systems, may be used to generate this input based on an initial input received from a user, a device, a proxy, and/or the like. A modified input generated by the input generator may then be provided to the language model, which will generate an output set of parameters. This output may be further evaluated with a reviewer, or other system, to ensure that the output is appropriate. Thereafter, a configuration file may be generated and/or the parameters may be directly provided to an environment to configure different components (e.g., camera settings, lighting, etc.) based on the parameters generated by the language model.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice-such an inference microservice (e.g., NVIDIA NIMs) which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

### EXAMPLE LANGUAGE MODELS

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases) such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type including but not limited to those described herein-may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models- or layers thereof-may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s) and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g., updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model -or version, instance, or agent-may be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 4A is a block diagram of an example generative language model system 400 suitable for use in implementing at least some embodiments of the present disclosure. In the example illustrated in FIG. 4A, the generative language model system 400 includes a retrieval augmented generation (RAG) component 492, an input processor 405, a tokenizer 410, an embedding component 420, plug-ins/APIs 495, and a generative language model (LM) 430 (which may include an LLM, a VLM, a multi-modal LM, etc.).

At a high level, the input processor 405 may receive an input 401 comprising text and/or other types of input data (e.g., audio data, video data, image data, sensor data (e.g., LiDAR, RADAR, ultrasonic, etc.), 3D design data, CAD data, universal scene descriptor (USD) data such as OpenUSD, etc.), depending on the architecture of the generative LM 430 (e.g., LLM/VLM/MMLM/etc.). In some embodiments, the input 401 includes plain text in the form of one or more sentences, paragraphs, and/or documents. Additionally or alternatively, the input 401 may include numerical sequences, precomputed embeddings (e.g., word or sentence embeddings), and/or structured data (e.g., in tabular formats, JSON, or XML). In some implementations in which the generative LM 430 is capable of processing multi-modal inputs, the input 401 may combine text (or may omit text) with image data, audio data, video data, design data, USD data, and/or other types of input data, such as but not limited to those described herein. Taking raw input text as an example, the input processor 405 may prepare raw input text in various ways. For example, the input processor 405 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 405 may remove stopwords to reduce noise and focus the generative LM 430 on more meaningful content. The input processor 405 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 492 (which may include one or more RAG models, and/or may be performed using the generative LM 430 itself) may be used to retrieve additional information to be used as part of the input 401 or prompt. RAG may be used to enhance the input to the LLM/VLM/MMLM/etc. with external knowledge, so that answers to specific questions or queries or requests are more relevant-such as in a case where specific knowledge is required. The RAG component 492 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 401 may be generated using the query or input to the model (e.g., a question, a request, etc.) in addition to data retrieved using the RAG component 492. In some embodiments, the input processor 405 may analyze the input 401 and communicate with the RAG component 492 (or the RAG component 492 may be part of the input processor 405, in embodiments) in order to identify relevant text and/or other data to provide to the generative LM 430 as additional context or sources of information from which to identify the response, answer, or output 490, generally. For example, where the input indicates that the user is interested in a desired tire pressure for a particular make and model of vehicle, the RAG component 492 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 492 may retrieve a prior stored conversation history—or at least a summary thereof—and include the prior conversation history along with the current ask/request as part of the input 401 to the generative LM 430.

The RAG component 492 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 492 and the embeddings of the chunks along with the embeddings of the query may be compared to identify the most similar/related embeddings to the query, which may be supplied to the generative LM 430 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 492 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 410 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 430 to understand morphological variations and handle out-of-vocabulary words more effectively. Character-based tokenization represents each character as a separate token, enabling the generative LM 430 to process text at a fine-grained level. The choice of tokenization strategy may depend on factors such as the language being processed, the task at hand, and/or characteristics of the training dataset. As such, the tokenizer 410 may convert the (e.g., processed) text into a structured format according to tokenization schema being implemented in the particular embodiment.

The embedding component 420 may use any known embedding technique to transform discrete tokens into (e.g., dense, continuous vector) representations of semantic meaning. For example, the embedding component 420 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 401 includes image data/video data/etc., the input processor 401 may resize the data to a standard size compatible with format of a corresponding input channel and/or may normalize pixel values to a common range (e.g., 0 to 1) to ensure a consistent representation, and the embedding component 420 may encode the image data using any known technique (e.g., using one or more convolutional neural networks (CNNs) to extract visual features). In some implementations in which the input 401 includes audio data, the input processor 401 may resample an audio file to a consistent sampling rate for uniform processing, and the embedding component 420 may use any known technique to extract and encode audio features-such as in the form of a spectrogram (e.g., a mel-spectrogram). In some implementations in which the input 401 includes video data, the input processor 401 may extract frames or apply resizing to extracted frames, and the embedding component 420 may extract features such as optical flow embeddings or video embeddings and/or may encode temporal information or sequences of frames. In some implementations in which the input 401 includes multi-modal data, the embedding component 420 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 430 and/or other components of the generative LM system 400 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 420 may apply an encoded representation of the input 401 to the generative LM 430, and the generative LM 430 may process the encoded representation of the input 401 to generate an output 490, which may include responsive text and/or other types of data.

As described herein, in some embodiments, the generative LM 430 may be configured to access or use—or capable of accessing or using—plug-ins/APIs 495 (which may include one or more plug-ins, application programming interfaces (APIs), databases, data stores, repositories, etc.). For example, for certain tasks or operations that the generative LM 430 is not ideally suited for, the model may have instructions (e.g., as a result of training, and/or based on instructions in a given prompt, such as those retrieved using the RAG component 492) to access one or more plug-ins/APIs 495 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 495 to the plug-in/API 495, the plug-in/API 495 may process the information and return an answer to the generative LM 430, and the generative LM 430 may use the response to generate the output 490. This process may be repeated -e.g., recursively-for any number of iterations and using any number of plug-ins/APIs 495 until an output 490 that addresses each ask/question/request/process/operation/etc. from the input 401 can be generated. As such, the model(s) may not only rely on its own knowledge from training on a large dataset(s) and/or from data retrieved using the RAG component 492, but also on the expertise or optimized nature of one or more external resources-such as the plug-ins/APIs 495.

FIG. 4B is a block diagram of an example implementation in which the generative LM 430 includes a transformer encoder-decoder. For example, assume input text such as “Who discovered gravity” is tokenized (e.g., by the tokenizer410 of FIG. 4A) into tokens such as words, and each token is encoded (e.g., by the embedding component 420 of FIG. 94A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 435 of the generative LM 430.

In an example implementation, the encoder(s) 435 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 440 may convert the context vector into attention vectors (keys and values) for the decoder(s) 445.

In an example implementation, the decoder(s) 445 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 435, in an example transformer architecture, each token (e.g., word) flows through a separate path in the decoder(s) 445. During a first pass, the decoder(s) 445, a classifier 450, and a generation mechanism 455 may generate a first token, and the generation mechanism 455 may apply the generated token as an input during a second pass. The process may repeat in a loop, successively generating and adding tokens (e.g., words) to the output from the preceding pass and applying the token embeddings of the composite sequence with positional encodings as an input to the decoder(s) 445 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 435, except that it creates its queries from the layer below it and takes the keys and values (e.g., matrix) from the output of the encoder(s) 435.

As such, the decoder(s) 445 may output some decoded (e.g., vector) representation of the input being applied during a particular pass. The classifier 450 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 455 may select or sample a word or token based on a corresponding predicted probability (e.g., select the word with the highest predicted probability) and append it to the output from a previous pass, generating each word or token sequentially. The generation mechanism 455 may repeat the process, triggering successive decoder inputs and corresponding predictions until selecting or sampling a symbol or token that represents the end of the response, at which point, the generation mechanism 455 may output the generated response.

FIG. 4C is a block diagram of an example implementation in which the generative LM 430 includes a decoder-only transformer architecture. For example, the decoder(s) 460 of FIG. 4C may operate similarly as the decoder(s) 445 of FIG. 4B except each of the decoder(s) 460 of FIG. 4C omits the encoder-decoder self-attention layer (since there is no encoder in this implementation). As such, the decoder(s) 460 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 460. As with the decoder(s) 445 of FIG. 4B, each token (e.g., word) may flow through a separate path in the decoder(s) 460, and the decoder(s) 460, a classifier 465, and a generation mechanism 470 may use auto-regression to sequentially generate one token at a time until predicting a symbol or token that represents the end of the response. The classifier 465 and the generation mechanism 470 may operate similarly as the classifier 450 and the generation mechanism 455 of FIG. 4B, with the generation mechanism 470 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### EXAMPLE COMPUTING DEVICE

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). As such, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that allow the computing device 500 to communicate with other computing devices via an electronic communication network, included wired and/or wireless communications. The communication interface 510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may allow the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that allow detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to allow the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### EXAMPLE DATA CENTER

FIG. 6 illustrates an example data center 600 that may be used in at least one embodiments of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R. s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark^{TM} (hereinafter “Spark”) that may use distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
identify one or more attributes of a scene comprising at least one object or environmental feature based at least on one or more representations of the scene;
determine, using a language model, a selection of an audio sample for the at least one object or environmental feature based on at least one attribute of the one or more attributes; and
generate at least one updated representation of the one or more representations of the scene, the at least one updated representation including the audio sample associated with the at least one object or environmental feature.

2. The one or more processors of claim 1, wherein the one or more circuits are to:
determine, using the language model, a position within the scene corresponding to an emission of the audio sample based at least on a corresponding position of the at least one object or environmental feature.

3. The one or more processors of claim 1, wherein the one or more circuits are to:
store a plurality of audio samples in association with corresponding metadata; and
generate the selection of the audio sample by providing the metadata as input to the language model.

4. The one or more processors of claim 3, wherein the metadata comprises a respective text description of each of the plurality of audio samples.

5. The one or more processors of claim 1, wherein the one or more circuits are to:
receive an input prompt identifying the at least one attribute of the scene; and
generate the selection of an audio sample for the at least one object or environmental feature based at least on the input prompt.

6. The one or more processors of claim 1, wherein the one or more circuits are to:
determine, using the language model, an instruction to generate the audio sample according to the at least one attribute of the scene; and
generate the selection of the audio sample by providing the instruction as input to a machine-learning model updated to generate audio samples.

7. The one or more processors of claim 6, wherein the machine-learning model comprises an audio diffusion model.

8. The one or more processors of claim 1, wherein the one or more circuits are to:
simulate the updated scene including the audio sample using at least one spatial audio function.

9. The one or more processors of claim 1, wherein the one or more circuits are to:
generate a representation of the updated scene in response to an interaction within an interactive application.

10. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a multi-modal language model;
a system for performing generative AI operations using a large language model (LLM);
a system for performing generative AI operations using a video language model (VLM);
a system for generating synthetic data;
a system incorporating one or more virtual machines (VMs);
a system using or deploying one or more inference microservices;
a system that incorporates one or more machine learning models deployed in a service or microservice along with an OS-level virtualization package (e.g., a container);
a system implemented at least partially in a data center; or
a system implemented at least partially using cloud computing resources.

11. A system, comprising:
one or more processors to:
determine, using a language model, a position at which sound associated with an object or environment feature is to be emitted within a three-dimensional (3D) scene;
generate, using a machine-learning model, an audio sample for the three-dimensional scene;
update the scene to include the audio sample at the position; and
provide the 3D scene and the audio sample for presentation.

12. The system of claim 11, wherein the one or more processors are to:
determine the position within the 3D scene by providing at least one rendering of the 3D scene as input to the language model.

13. The system of claim 11, wherein the machine-learning model is an audio diffusion model.

14. The system of claim 11, wherein the machine-learning model is the language model, and wherein the language model comprises a multimodal language model updated to generate audio data.

15. The system of claim 11, wherein the one or more processors are to:
generate the audio sample further based on a text input prompt that specifies an attribute of the 3D scene.

16. The system of claim 11, wherein the one or more processors are to:
provide the audio sample for presentation using at least one spatial audio function.

17. The system of claim 11, wherein the one or more processors are to:
determine, using the language model, at least one attribute of the audio sample; and
generate the audio sample using the machine-learning model and the attribute.

18. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a multi-modal language model;
a system for performing generative AI operations using a large language model (LLM);
a system for performing generative AI operations using a video language model (VLM);
a system for generating synthetic data;
a system incorporating one or more virtual machines (VMs);
a system using or deploying one or more inference microservices;
a system that incorporates one or more machine learning models deployed in a service or microservice along with an OS-level virtualization package (e.g., a container);
a system implemented at least partially in a data center; or a system implemented at least partially using cloud computing resources.

19. A method, comprising:
identifying, using one or more processors, a scene comprising at least one object or environmental feature based on one or more representations of the scene;
determining, using the one or more processors and a language model, a selection of an audio sample for the at least one object or environmental feature; and
generating, using the one or more processors, at least one updated representation of the one or more representations of the scene, the at least one updated representation including the audio sample associated with the at least one object or environmental feature.

20. The method of claim 19, further comprising:
determining, using the one or more processors and the language model, a position for the audio sample within the scene based at least on a corresponding position of the at least one object or environmental feature.
